(19) United States
(12) Patent Application Publication
(10) Pub. No.: US 2008/0212587 A1
(43) Pub. Date: Sep. 4, 2008

(54) RELAY APPARATUS AND PACKET RELAY METHOD

(75) Inventor: Koichi YAMASAKI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki-shi (JP)

(21) Appl. No.: 12/039,450

(22) Filed: Feb. 28, 2008

(30) Foreign Application Priority Data
Mar. 2, 2007 (JP) JP2007-53153

(51) Int. Cl. H04L 12/56

(52) U.S. Cl. 370/392

(57) ABSTRACT

A relay apparatus to relay packets transmitted/received between apparatuses connected via a network and method. The relay apparatus includes physical ports to transmit/receive the packets. The relay apparatus also rewrites transmission-destination identification information of a packet transmitted to the relay apparatus based on a transfer rule stored in advance. The relay apparatus also transfers control for performing control so that the packet in which the transmission-destination identification information has been rewritten is output from one of the physical ports based on the transfer rule.

### CROSS-REFERENCE TO RELATED APPLICATIONS

This application claims the benefit of Application No. 2007-053153, filed Mar. 2, 2007, in the Japanese Patent Office, the disclosure of which is incorporated herein by reference.

### BACKGROUND

1. Technical Field

The present disclosure relates to a relay apparatus to relay packets transmitted/received between apparatuses mutually connected via a network and a packet relay method.

2. Description of the Related Art

In a network using TCP/IP (Transmission Control Protocol/Internet Protocol), each apparatus as a transmission source or a transmission destination is identified based on an identification number called an IP address. Thus, different IP addresses are typically assigned to respective apparatuses connected in a network.

However, some apparatuses, such as those being developed, may be assigned with an IP address common to that of another apparatus and may not have a function of changing the assigned IP address. When such apparatuses are to be connected to a network for a test or the like, an apparatus having a same IP address needs to be disconnected from the network before connecting an apparatus to be tested in order to prevent overlap of IP addresses in the network, which is a complicated operation.

Under these circumstances, a technique enabling apparatuses assigned with overlapped IP addresses to be connected to the same network has been required.

However, such techniques are predicated on respective apparatuses being assigned with overlapped IP addresses communicate with different apparatuses. Thus, such techniques have a problem that apparatuses assigned with overlapped IP addresses cannot communicate with a common apparatus.

For example, in a case where apparatuses “a” and “b” assigned with overlapped IP addresses are connected to network A, if apparatus “c” connected to network A is capable of communicating with apparatus “a”, apparatus “b” cannot communicate with apparatus “c”.

The present disclosure overcomes the above disclosed, and other problems of the related art.

### SUMMARY

According to an embodiment t of the present disclosure, a relay apparatus to relay packets transmitted/received between apparatuses connected via a network includes a plurality of physical ports to transmit/receive the packets. The relay apparatus will also rewrite the transmission-destination for rewriting transmission-destination identification information of a packet transmitted to the relay apparatus based on a transfer rule stored in advance. The apparatus will also control transfer for performing control so that the packet in which the transmission-destination identification information has been rewritten by the transmission-destination is output from one of the physical ports based on the transfer rule.

According to an embodiment of the present disclosure, a packet relay method for relaying packets transmitted/received between apparatuses connected via a network, the method being used in a relay apparatus including a plurality of physical ports to transmit/receive the packets includes rewriting a transmission-destination of rewriting transmission-destination identification information of a packet transmitted to the relay apparatus based on a transfer rule stored in advance, wherein the packet in which the transmission-destination identification information has been rewritten in the transmission-destination rewriting operation is output from one of the physical ports based on the transfer rule.

Additional aspects and/or advantages will be set forth in part in the description which follows and, in part, will be apparent from the description.

### BRIEF DESCRIPTION OF THE DRAWINGS

FIG. 1 is a block diagram illustrating an embodiment of a network system;

FIG. 2 is a block diagram illustrating an embodiment of a relay apparatus;

FIG. 3 illustrates an example of a path table;

FIG. 4 is a flowchart illustrating an example operation performed when an example relay apparatus receives a packet; and

FIG. 5 is a flowchart illustrating an example operation performed when the relay apparatus receives a packet.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout.

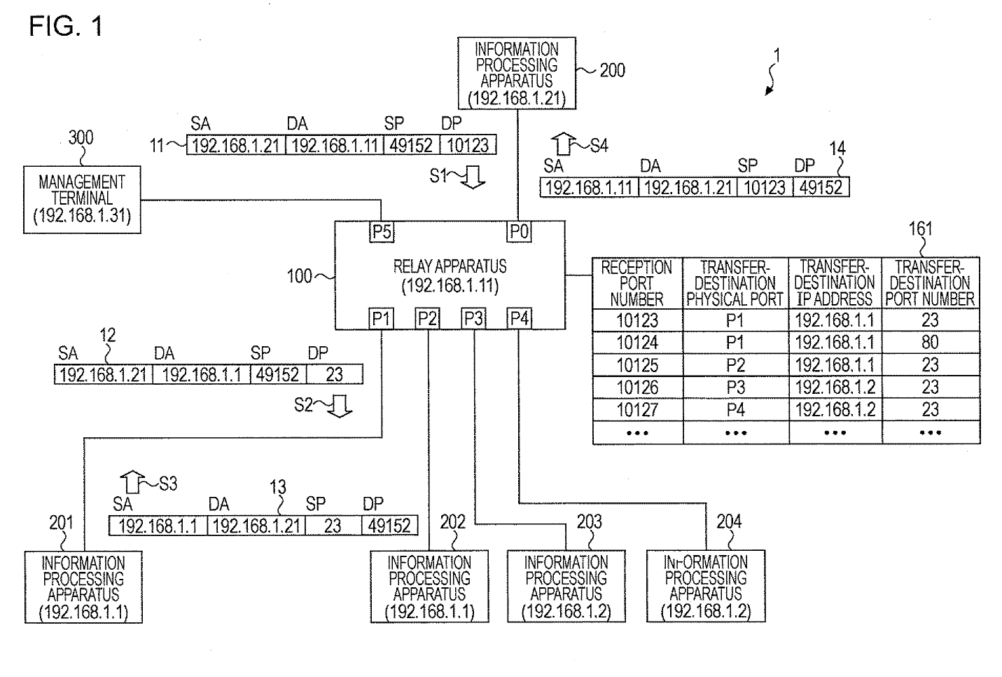

An overview according to an embodiment is illustrated in FIG. 1.

As illustrated in FIG. 1, information processing apparatuses 200 to 204 and a management terminal 300 are mutually connected via a relay apparatus 100 in a network 1.

Each of the information processing apparatuses 200 to 204 can have a network connecting function by TCP/IP. An IP address, e.g., “192.168.1.21” is assigned to the information processing apparatus 200. An IP address, e.g., “192.168.1.1” is assigned to the information processing apparatuses 201 and 202. An IP address, e.g., “192.168.1.2” is assigned to the information processing apparatuses 203 and 204.

In the network 1, two apparatuses are assigned with the IP address, e.g., “192.168.1.1” and two apparatuses assigned with the IP address, e.g., “192.168.1.2” are connected.

The management terminal 300 is a terminal for managing the network 1. For example, the management terminal 300 issues a management command to the relay apparatus 100 in order to update setting of the relay apparatus 100 or obtain various statuses of the relay apparatus 100 and so on.

The relay apparatus 100 is an apparatus to relay packets transmitted/received among the information processing apparatuses 200 to 204. The relay apparatus 100 can function as a normal layer 2 switch and also enable normal communication even when apparatuses assigned with overlapped IP addresses are connected in the same network. The relay apparatus 100 can be assigned with an IP address, e.g., “192.168.1.11”.

The relay apparatus 100 stores a transfer rule table, e.g., 161. By transferring a packet with reference to the transfer rule table 1611 the relay apparatus 100 can realize normal communication even when a plurality of apparatuses assigned with overlapped IP addresses are connected in the same network. In the transfer rule table 161, a rule indicating how a packet transmitted to the relay apparatus 100 should be transferred can be set, and the transfer rule table 161 can have the following items: reception port number, transfer-destination physical port, transfer-destination IP address, and transfer-destination port number.

The reception port number can indicate a transmission-destination port number set in a packet transmitted to the relay apparatus 100. The transfer-destination physical port, the transfer-destination IP address, and the transfer-destination port number can indicate how a packet transmitted to the relay apparatus 100 should be transferred, when the packet has a transmission-destination port number that matches the reception port number in the same row.

For example, in the first row of the transfer rule table 161 illustrated in FIG. 1, the reception port number is “10123”, the transfer-destination physical port is “P1”, the transfer-destination IP address is “192.168.1.1”, and the transfer-destination port number is “23”. This means that, if a packet having a transmission-destination port number “10123” can be transmitted to the relay apparatus 100, the transmission-destination IP address and the transmission-destination port number of the packet should be rewritten to “192.168.1.1” and “23” and then the packet should be transmitted from the physical port “P1”.

The transmission-destination port number can be an identification number that can be used in combination with a transmission-destination IP address in order to specify the other end of communication based on the TCP/IP. For example, the transmission-destination port number can be used to specify a service to be provided among a plurality of services provided by the other end of communication. The physical port can be a terminal to which a network cable connecting apparatuses can be connected. The relay apparatus 100 can be connected to a plurality of apparatuses via network cables and thus includes a plurality of physical ports.

A packet relay method according to the an embodiment is disclosed by using an example where a packet can be transmitted/received between the information processing apparatuses 200 and 201, as an example. In this example, the information processing apparatus 200 needs to be provided with a service from the information processing apparatus 201 and that the information processing apparatus 200 needs to transmit a packet having a transmission-destination port number “23” to the information processing apparatus 201 in order to receive the service.

In this example, the information processing apparatus 200 may transmit a packet having a transmission-destination IP address, e.g., “192.168.1.1” and a transmission port number “23”. However, since there are two apparatuses assigned with the IP address, e.g., “192.168.1.1” connected in the network 1, the transmission destination of the packet cannot be specified and a transmission error occurs in such a packet transmitting method.

Thus, the information processing apparatus 200 does not directly transmit the packet to the information processing apparatus 201, and requests transfer of the packet to the relay apparatus 100. In the example illustrated in FIG. 1, the relay apparatus 100 can be connected to the information processing apparatus 201 via the physical port P1. Also, the setting enabling the relay apparatus 100 to transfer the packet having the transmission-destination IP address, e.g., “192.168.1.1” and the transmission-destination port number “23” via the physical port “P1” can be recorded in the first row of the transfer rule table 161.

Then, the information processing apparatus 200 transmits a packet 11, which has a transmission-source IP address (SA), e.g., “192.168.1.21”, a transmission-destination IP address (DA) “192.168.1.11”, a transmission-source port number (SP) “49152”, and a transmission-destination port number (DP) “10123”, to the relay apparatus 100 (operation S1). Here, “10123” specified as a transmission-destination port number is the value of the reception port number in the first row of the transfer rule table 161, and “49152” specified as a transmission-source port number is a number that is arbitrarily selected from among unused port numbers.

The relay apparatus 100 that has received the packet 11 can determine that the transmission-destination IP address of the packet 11 matches the IP address assigned to the relay apparatus 100, and then can search the transfer rule table 161 for a row including “10123”, which is the transmission-destination port number of the packet 11, as a reception port number. In this case, the row exists in the first row of the transfer rule table 161. Thus the relay apparatus 100 can generate a packet 12 by rewriting the transmission-destination IP address of the packet 11 to, e.g., “192.168.1.1” and the transmission-destination port number to “23” in accordance with the setting in the row, and transmits the packet 12 from the physical port “P1” (operation S2).

Accordingly, the packet having the transmission-destination IP address, e.g., “192.168.1.1” and the transmission-destination port number “23” can be transmitted from the information processing apparatus 200 to the information processing apparatus 201. Likewise, in the example illustrated in FIG. 1, if the information processing apparatus 200 transmits a packet having a transmission-destination port number, e.g., “10125” to the relay apparatus 100, a packet having a transmission-destination port number “23” can be transmitted to the information processing apparatus 202 via a physical port P2.

Also, if the information processing apparatus 200 transmits a packet having a transmission-destination port number, e.g., “10126” to the relay apparatus 100, a packet having a transmission-destination port number “23” can be transmitted to the information processing apparatus 203 via a physical port P3. Also, if the information processing apparatus 200 transmits a packet having a transmission-destination port number “10127” to the relay apparatus 100, a packet having a transmission-destination port number “23” can be transmitted to the information processing apparatus 204 via a physical port P4.

In this way, according to the embodiment, the packet transfer rule can include specification of a physical port for outputting a packet. Thus, even when a plurality of apparatuses assigned with overlapped IP addresses are connected in the same network, a packet can be correctly transmitted to a desired apparatus by connecting the plurality of apparatuses to different physical ports of the relay apparatus 100.

In an example case where the information processing apparatus 201 needs to transmit a response to the packet to the information processing apparatus 200, the information processing apparatus 201 inverts the transmission source and the transmission destination of the packet 12, that is, generates a packet 13 having a transmission-source IP address, e.g., “192.168.1.1”, a transmission-destination IP address, e.g., “192 168. 1.21”, a transmission-source port number “23”, and a transmission-destination port number “49152”, and then transmits the packet 13 (operation S3).

The relay apparatus 100 that has received the packet 13 determines that the transmission-destination IP address of the packet 13 does not match the IP address assigned to the relay apparatus 100, and can obtain the physical port “P1” where the packet 13 was received as a value of the transfer-destination physical port. Also, the relay apparatus 100 can search the transfer rule table 161 for a row including the transmission-source IP address, e.g., “192.168.1.1”, and the transmission-source port number “10123” as the transfer-destination IP address and the transfer-destination port number.

In this case, the row exists in the first row of the transfer rule table 161, and thus the relay apparatus 100 rewrites the transmission-source port number of the packet 13 to “10123” in accordance with the setting in the row. Furthermore, the relay apparatus 100 rewrites the value of the transmission-source IP address to, e.g., “192.168.1.11”, which is the IP address assigned to the relay apparatus 100, so as to generate a packet 14, and then transmits the packet 14 to the information processing apparatus 200 (operation S4).

In this way, if the destination of a received packet is not the relay apparatus 100, the relay apparatus 100 can perform an IP address rewriting process in a manner opposite to that in a case of receiving a packet addressed to the relay apparatus 100. If this rewriting process is not performed and if the information processing apparatus 200 transmits a packet in which the transmission source and the transmission destination are inverted in order to respond to the packet 14, the packet having the transmission-destination IP address, e.g., “192.168.1.1” and the transmission-destination port number “23” is transmitted, which causes a transmission error.

In the example illustrated in FIG. 1, an apparatus can be connected to each physical port of the relay apparatus 100. Alternatively, a plurality of apparatuses may be connected to each physical port of the relay apparatus 100 via another layer 2 switch or the like. In that case, the apparatuses connected to the same physical port should have IP addresses different from each other.

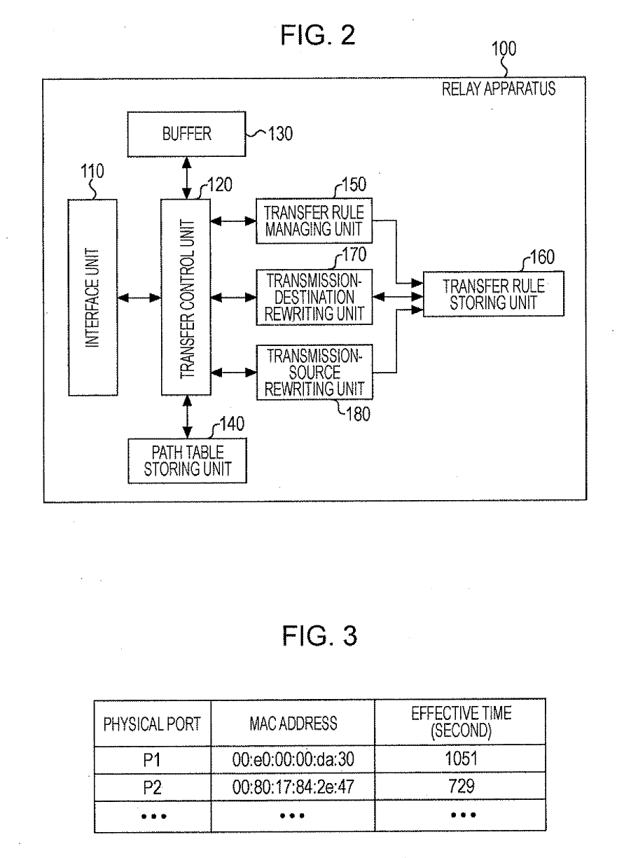

Next, an example configuration of the relay apparatus 100 illustrated in FIG. 1 is disclosed. FIG. 2 is a block diagram illustrating a configuration of the relay apparatus 100. As illustrated in FIG. 2, the example relay apparatus 100 can include an interface unit 110, a transfer control unit 120, a buffer 130, a path table storing unit 140, a transfer rule managing unit 150, a transfer rule storing unit 160, a transmission-destination rewriting unit 170, and a transmission-source rewriting unit 180.

The interface unit 110 can be used to transmit/receive packets via the network and can include a plurality of physical ports identified by numbers “P0”, “P1”, and so on.

The transfer control unit 120 can be a processing unit to temporarily store a packet received by the interface unit 110 in the buffer 130, rewrite a MAC address as necessary, and transfer the packet. The MAC address is an identification number used to identify the other end of communication, e.g., in communication of layer 2, which is a lower layer of the TCP/IP.

The transfer control unit 120 allows the path table storing unit 140 to store a path table indicating correspondence between the transmission-source MAC address of a received packet and the physical port where the packet was received. Then, the transfer control unit 120 can perform a process of transferring the received packet based on the stored path table.

FIG. 3 illustrates an example of the path table. As illustrated in FIG. 3, the path table can include the following items: physical port, MAC address, and effective time. The physical port indicates the physical port where a packet was received, and the MAC address indicates the transmission-source MAC address of a received packet. The effective time indicates the time period when the information in the row in the path table is regarded as effective, and is used to delete a row that is not necessary any more.

In this way, the transfer control unit 120 can learn the MAC address of the apparatus that was transmitted a packet and the physical port where the packet was received, and performs a packet transferring process based on the information.

As described below, the transfer control unit 120 calls the function of the transfer rule managing unit 150, the transmission-destination rewriting unit 170, and the transmission-source rewriting unit 180, as necessary, in order to realize normal communication with the apparatuses assigned with overlapped IP addresses.

The transfer rule managing unit 150 manages the transfer rule table 161 stored in the transfer rule storing unit 160. If a management command is transmitted from the management terminal 300 to the relay apparatus 100, the transfer rule managing unit 150 is requested to deal with the management command from the transfer control unit 120 and performs update or the like of the transfer rule table 161 stored in the transfer rule storing unit 160.

If a management command to inquire about the content of the transfer rule table 161 is transmitted from the information processing apparatus 200 or the like, the transfer rule managing unit 150 responds to the inquiry, that is, transmits the content of the transfer rule table 161. By receiving the response indicating the content of the transfer rule table 161, a user of the information processing apparatus 200 can know the transmission-destination port number to be specified to transmit a packet to a desired apparatus via the relay apparatus 100.

Whether a packet transmitted to the relay apparatus 100 contains a management command to request a process to the relay apparatus 100, or a management command to request transfer of the packet to another apparatus can be determined based on the transmission-destination port number of the packet.

The transmission-destination rewriting unit 170 can be a processing unit to rewrite the transmission-destination IP address and the transmission-destination port number of a packet to be transferred by the relay apparatus 100, in accordance with the content of the transfer rule table 161 stored in the transfer rule storing unit 160.

If a packet addressed to the relay apparatus 100 is transmitted from the information processing apparatus 200, the transmission-destination rewriting unit 170 is requested to deal with the packet by the transfer control unit 120. Then, the transmission-destination rewriting unit 170 searches the transfer rule table 161 for a row defining a rule to transfer the requested packet. If the row is found in the transfer rule table 161, the transmission-destination rewriting unit 170 can rewrite s the destination of the packet in accordance with the information in the row and instructs the transfer control unit 120 to transmit the packet from the physical port specified in the row. On the other hand, if the row does not exist in the transfer rule table 161, the packet can be discarded.

The transmission-source rewriting unit 180 is a processing unit to rewrite the transmission-source IP address and the transmission-source port number of a packet transmitted, as a response to the packet transferred by the relay apparatus 100 in accordance with the content of the transfer rule table 161 stored in the transfer rule storing unit 160.

If an apparatus that has received a packet transferred by the relay apparatus 100 transmits a response packet in which the transmission-source apparatus can be specified as a transmission destination and the apparatus can be specified as a transmission source, the response packet is received by the relay apparatus 100 existing on a communication path. Since the destination of the packet is not the relay apparatus 100, the transmission-source rewriting unit 180 is requested to deal with the packet by the transfer control unit 120.

Then, the transmission-source rewriting unit 180 searches the transfer rule table 161 for a row defining a rule to transfer the packet to the transmission source of the packet to be transferred. If the row is found in the transfer rule table 161, the transmission-source rewriting unit 180 rewrites the transmission-source port number of the packet to the value of the reception port number in the row. Furthermore, the transmission-source rewriting unit 180 can rewrite the transmission-source IP address to the IP address assigned to the relay apparatus 100, and instructs the transfer control unit 120 to transfer the packet in accordance with the path table stored in the path table storing unit 140.

On the other hand, if the row does not exist in the transfer rule table 161, the transmission-source rewriting unit 180 does not rewrite the identification information of the transmission source and, for example, instructs the transfer control unit 120 to transfer the packet in accordance with the path table stored in the path table storing unit 140.

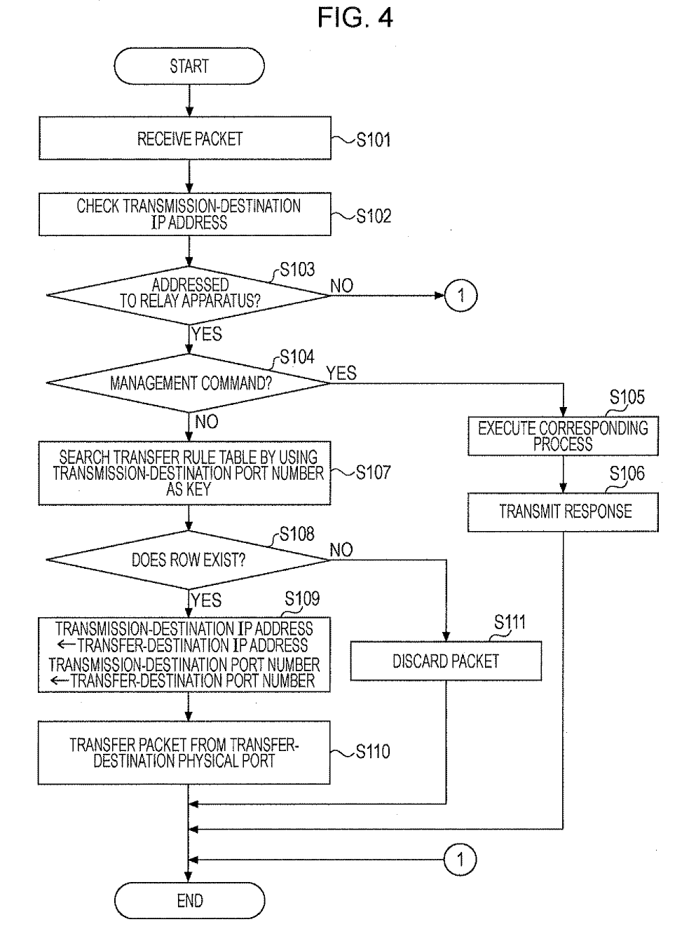

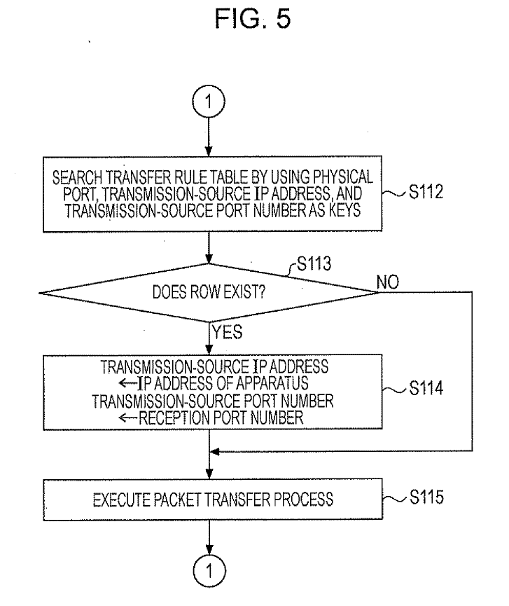

Next, an example operation of the relay apparatus 100 is disclosed. FIGS. 4 and 5 are example flowcharts illustrating an example operation performed when the relay apparatus 100 receives a packet. As illustrated in FIG. 4, if the interface unit 110 of the relay apparatus 100 receives a packet (operation S101), the transfer control unit 120 determines whether the transmission-destination IP address of the packet matches the IP address assigned to the relay apparatus 100 (operation S102).

If the transmission-destination IP address of the received packet matches the IP address assigned to the relay apparatus 100 (YES in operation S103), the process proceeds depending on whether the content of the packet is a management command. If the content of the packet is a management command to request update or inquiry of the transfer rule table 161 (YES in operation S104), the transfer rule managing unit 150 executes a process corresponding to the management command (operation S105) and transmits a result as a response (operation S106).

On the other hand, if the content of the packet is not a management command (NO in operation S104), the transmission-destination rewriting unit 170 searches the transfer rule table 161 for a row including the reception port number whose value is the same as that of the transmission-destination port number of the received packet (operation S107). If the row is found in the transfer rule table 161 (YES in operation S108), the transmission-destination rewriting unit 170 sets the transfer-destination IP address and the transfer-destination port number in the row to the transmission-destination IP address and the transmission-destination port number of the received packet (operation S109), and transfers the packet from the physical port corresponding to the transfer-destination physical port in the row (operation S110).

If the row does not exist in the transfer rule table 161 (NO in operation S108), the transmission-destination rewriting unit 170 discards the received packet (operation S111).

If it is determined in operation S102 that the transmission-destination IP address of the received packet is not the IP address assigned to the relay apparatus 100 (No in operation S103), as illustrated in FIG. 5, the transmission-source rewriting unit 180 obtains the number of the physical port where the packet was received as the value of the transfer-destination physical port. Then, the transmission-source rewriting unit 180 searches the transfer rule table 161 for a row including the transfer-destination IP address and the transfer-destination port number whose values are the same as those of the transmission-source IP address and the transmission-source port number of the received packet (operation S112).

If the row is found in the transfer rule table 161 (YES in operation S113), the transmission-source rewriting unit 180 sets the reception port number in the row and the IP address assigned to the relay apparatus 100 to the transmission-source port number and the transmission-source IP address of the received packet (operation S114), and allows the transfer control unit 120 to transfer the packet (operation S115).

On the other hand, if the row does not exist in the transfer rule table 161 (NO in operation S113), the transmission-source rewriting unit 180 does not rewrite the identification information of the transmission source of the received packet and allows the transfer control unit 120 to transfer the packet (operation S115).

As disclosed above, according to the an embodiment, the transmission-destination address and other data of a packet transmitted to the relay apparatus 100 can be rewritten in accordance with the predefined transfer rule table 161, and then the packet is output from a predetermined physical port. Thus, even when a plurality of apparatuses assigned with overlapped IP addresses are connected in the same network, an apparatus can communicate with any of the apparatuses assigned with the overlapped IP addresses by connecting the apparatuses to different physical ports of the relay apparatus 100.

As disclosed above, the relay apparatus and the packet relay method according to the embodiment are useful to relay packets transmitted/received between apparatuses connected via a network. The apparatus and method can be used e in a case where a plurality of apparatuses assigned with overlapped IP addresses are connected to the same network and an apparatus needs to communicate with any of the apparatuses assigned with the overlapped IP addresses.

According to an embodiment, the transmission-destination address of a packet transmitted to the relay apparatus can be rewritten in accordance with a predefined transfer rule and then the packet is output from a predetermined physical port. Thus, even when apparatuses assigned with overlapped IP addresses are connected to the same network, an apparatus can communicate with any of the apparatuses assigned with the overlapped IP addresses by connecting the apparatuses to different physical ports of the relay apparatus.

According to an embodiment, the transfer rule can be defined so that the physical port from which a packet is output is determined based on the transmission-destination port number. Thus, by changing the transmission-destination port number of the packet to be transmitted as necessary, an apparatus can communicate with any of the apparatuses assigned with the overlapped IP addresses.

According to an embodiment, if a packet transmitted as a response to a packet transferred based on the transfer rule is received by the relay apparatus, the relay apparatus can rewrite the transmission source of the packet to the relay apparatus and then transfers the packet. Thus, a packet in which an appropriate transmission source is set can be transferred as a response to the originally transmitted packet.

According to an embodiment, the relay apparatus can transmit the content of the transfer rule as a response when receiving an inquiry. Thus, a user of another apparatus can know how they e should transmit a packet in order to transfer the packet to a desired apparatus.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A relay apparatus to relay packets transmitted/received between apparatuses connected via a network, the relay apparatus comprising:
a plurality of physical ports to transmit/receive the packets;
transmission-destination rewriting means for rewriting transmission-destination identification information of a packet transmitted to the relay apparatus based on a transfer rule stored in advance; and
transfer control means for performing control so that the packet in which the transmission-destination identification information has been rewritten by the transmission-destination rewriting means is output from one of the physical ports based on the transfer rule.

2. The relay apparatus according to claim 1, wherein the transfer rule includes a transmission-destination port number of the packet transmitted to the relay apparatus, information to rewrite the transmission-destination identification information of the packet having the transmission-destination port number, and information of the physical port from which the packet having the transmission-destination port number should be output, those pieces of information being associated with each other.

3. The relay apparatus according to claim 1, further comprising:
transmission-source rewriting means for rewriting transmission-source identification information so that the transmission source of a received packet is the relay apparatus when the transmission-source identification information of the received packet matches rewritten transmission-destination identification information of the packet to be transferred after being rewritten based on the transfer rule and when the physical port where the packet was received matches the physical port to output the packet to be transferred,
wherein the transfer control means transfers the packet of which transmission-source identification information has been rewritten by the transmission-source rewriting means in accordance with the transmission-destination identification information.

4. The relay apparatus according to claim 1, further comprising transfer rule managing means for transmitting content of the transfer rule in response to an inquiry.

5. A packet relay method for relaying packets transmitted/received between apparatuses connected via a network, the method being used in a relay apparatus including a plurality of physical ports to transmit/receive the packets, comprising:
rewriting a transmission-destination identification information of a packet transmitted to the relay apparatus based on a transfer rule stored in advance,
wherein the packet in which the transmission-destination identification information has been rewritten is output from one of the physical ports based on the transfer rule.

6. The packet relay method according to claim 5, further comprising:
rewriting transmission-source identification information so that the transmission source of a received packet is the relay apparatus when the transmission-source identification information of the received packet matches rewritten transmission-destination identification information of the packet to be transferred after being rewritten based on the transfer rule and when the physical port where the packet was received matches the physical port to output the packet to be transferred,
wherein the packet of which transmission-source identification information has been rewritten is transferred in accordance with the transmission-destination identification information.
